(19) United States
(12) Patent Application Publication
(10) Pub. No.: US 2015/0330600 A1
(43) Pub. Date: Nov. 19, 2015

(54) REFLECTOR

(71) Applicant: 3M INNOVATIVE PROPERTIES COMPANY, St. Paul, MN (US)

(72) Inventors: Gina M. Albanese, Minneapolis, MN (US); Todd E. Bracher, Brooklyn, NY (US); Gilles J.B. Benoit, Minneapolis, MN (US); Zhaohui Yang, North Oaks, MN (US)

(21) Appl. No.: 14/711,425

(22) Filed: May 13, 2015

Related U.S. Application Data
(60) Provisional application No. 61/992,704, filed on May 13, 2014.

(51) Int. Cl. F21V 7/08; F21S 8/00

(52) U.S. Cl. CPC F21V 7/08; F21S 8/033; F21Y 2101/02

(57) ABSTRACT

A reflector and a light fixture that includes the reflector are provided, where the reflector has a reflecting surface having a shape which closely approximates a determined surface which is series of ellipsoidal section segments, wherein each ellipsoidal section segment has a first focus A and a second focus B, wherein first focus A is the same point for each ellipsoidal section segment, and wherein, for successive ellipsoidal section segments, focus B is at a successive location along a line. In some embodiments, the light fixture additionally comprises a light source, typically located at focus A. The present disclosure enables the projection of a visually striking, linearly extended pattern of light on a wall from a fixture mounted on that same wall, where the fixture may furthermore have very little depth, i.e., orthogonal extension outward from that wall.

### FIELD OF THE DISCLOSURE

This disclosure relates to a reflector and to a light fixture that includes the reflector.

### SUMMARY OF THE DISCLOSURE

Briefly, the present disclosure provides a reflector having a reflecting surface having a shape which closely approximates a determined surface which is series of ellipsoidal section segments, wherein each ellipsoidal section segment has a first focus A and a second focus B, wherein first focus A is the same point for each ellipsoidal section segment, and wherein, for successive ellipsoidal section segments, focus B is at a successive location along a line. In some embodiments, the line is a straight line; in some, a curved line; in some, a curved line curving in a single direction; and in some a curved line curving successively in alternating directions. In some embodiments the reflecting surface has a shape which closely approximates the determined surface in that it varies by less than +/−10% from the determined surface; in some by less than +/−5%. Additional embodiments of the reflector of the present disclosure are described below under “Selected Embodiments.”

In another aspect, the present disclosure provides a light fixture comprising the reflector according to the present disclosure. In some embodiments, the light fixture additionally comprises a light source, typically located at focus A. In some embodiments, the light source is a lambertian light source. In some embodiments, the light source is an LED. In some embodiments, the light fixture is adapted to be mounted on a planar surface, such that when mounted said line will fall in the plane of the planar surface. In some embodiments, the planar surface is a wall of a building; in some embodiments an exterior wall and in some embodiments an interior wall. In some embodiments, the light fixture when mounted has a depth, the depth measured orthogonal to the planar surface, wherein the depth is not more than 15 cm; in some embodiments not more than 12 cm; in some embodiments not more than 10 cm; and in some embodiments not more than 9 cm. In some embodiments the depth is not more than 10% of the length of the line, as measured from the light fixture; in other embodiments not more than 6% of the length of the line.

The present disclosure enables the projection of a visually striking, linearly extended pattern of light on a wall from a fixture mounted on that same wall, where the fixture may furthermore have very little depth, i.e., orthogonal extension outward from that wall.

In this application:

“closely approximates” means varies by less than +/−20%, and when so specified may mean one of the following: varies by less than +/−15%, varies by less than +/−10%, varies by less than +/−5%, varies by less than +/−3%, or varies by less than +/−1%.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

### BRIEF DESCRIPTION OF THE DRAWING

FIG. 1 is a view of one embodiment of a light fixture according to the present disclosure mounted on an interior wall and casting light on a straight line in the plane of the wall.

FIG. 2 is a front angle of one embodiment of a light fixture according to the present disclosure mounted on a wall.

FIG. 3 is a three-quarter angle view of one embodiment of a light fixture according to the present disclosure mounted on a wall.

FIG. 4A is a side view of one embodiment of a light fixture according to the present disclosure mounted on a wall and additionally depicts light rays emanating from a point source in the light fixture and striking the wall.

FIGS. 4B-D are graphs demonstrating, for the light fixture depicted in FIG. 4A, intensity of light striking the wall.

FIGS. 5A-E are, respectively, top, side, bottom, back and angle views of one embodiment of a light fixture according to the present disclosure.

### DETAILED DESCRIPTION

Briefly, the present disclosure provides a reflector having a reflecting surface having a shape which closely approximates a determined surface. As used herein, “reflecting surface” refers to the actual surface of the physical reflector item and “determined surface” is the theoretical design intended for the reflecting surface. The determined surface is series of ellipsoidal section segments. Each ellipsoidal section segment has a first focus A and a second focus B, where first focus A is the same point for each ellipsoidal section segment, and where, for successive ellipsoidal section segments, focus B is at a successive location along a line. In various embodiments, the line can be a straight line, a curved line, a curved line curving in a single direction (“C”-curve), or a curved line curving successively in alternating directions (“S”-curve).

In another aspect, the present disclosure provides a light fixture comprising the reflector according to the present disclosure. In some embodiments the light fixture comprises a light source, which is typically located at or near to focus A, typically within a millimeter of focus A. In some embodiments the light source is a lambertian light source. In some embodiments the light source is an LED.

In some embodiments, the light fixture is adapted to be mounted on a planar surface, such that when mounted the line will fall in the plane of the planar surface. The planar surface is typically an architectural surface such as an interior or exterior wall of a building. In some embodiments, the light fixture is adapted to be mounted on a planar surface by the provision of mounting points, brackets, or the like.

In some embodiments, the light fixture is adapted to be mounted on a planar surface, such that it can cast a line of light for a relatively long distance, yet the light fixture extends from the wall to a relatively little distance. In some embodiments, the light fixture has a depth (i.e., the dimension of the light fixture orthogonal to the planar surface when it is mounted to a planar surface) which is not more than 15 cm, in some embodiments not more than 12 cm, in some embodiments not more than 10 cm, in some embodiments not more than 10 cm, and in some embodiments not more than 9 cm. In some embodiments, the light fixture depth is not more than 10% of the length of the line cast by the fixture, measured from the light fixture; in some embodiments not more than 8%, and in some embodiments not more than 6%.

Objects and advantages of this disclosure are further illustrated by the following embodiment, but the particular materials and amounts thereof recited in these embodiments, as well as other conditions and details, should not be construed to unduly limit this disclosure.

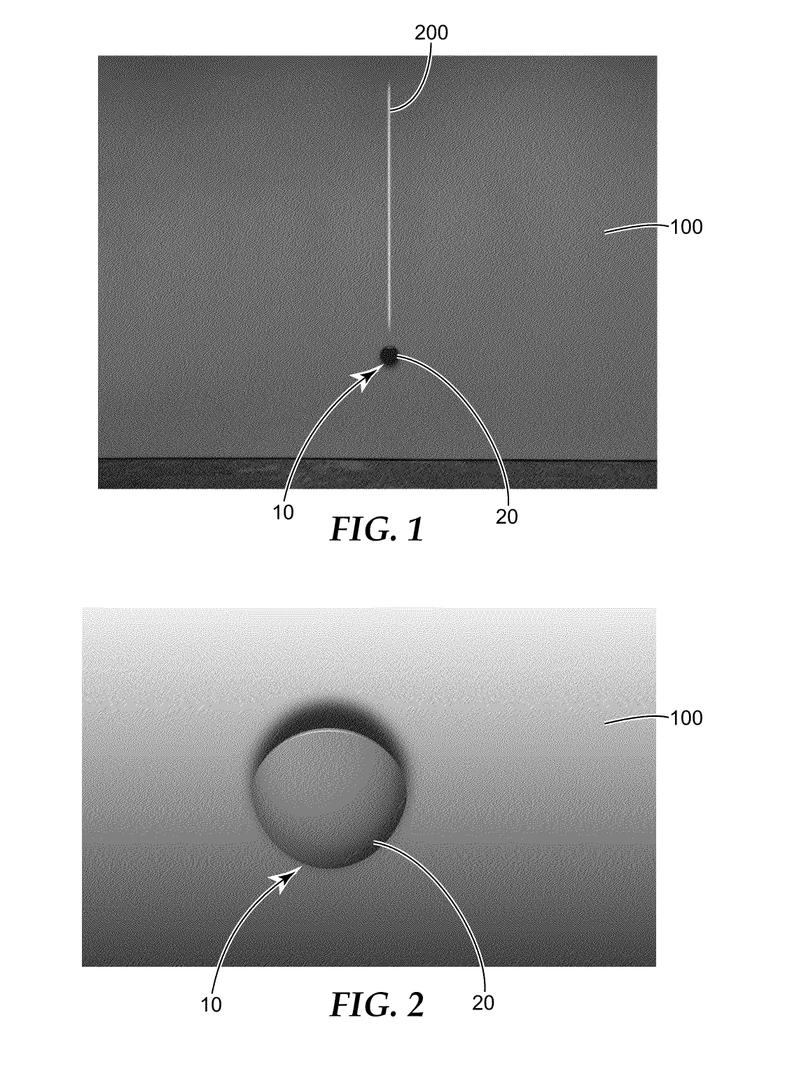

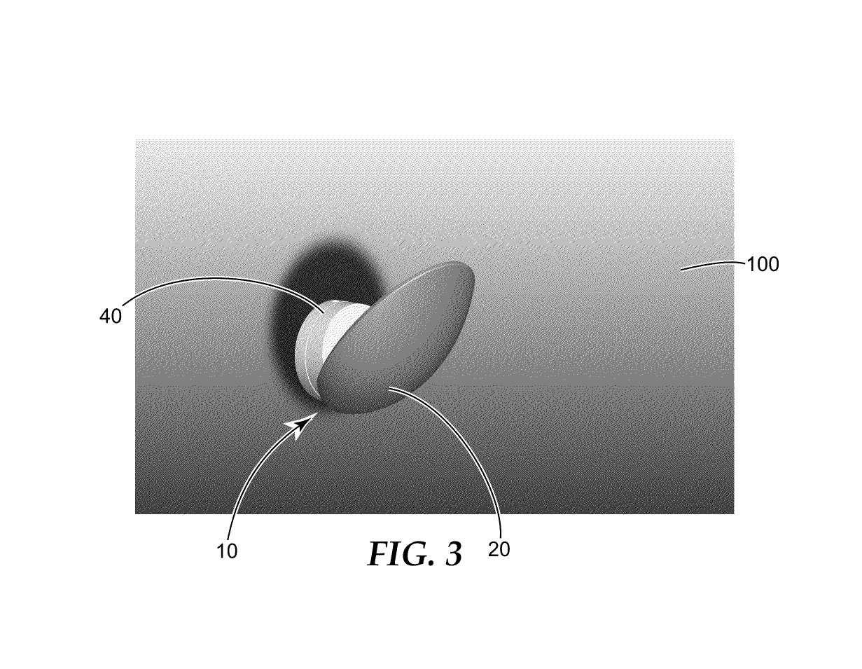

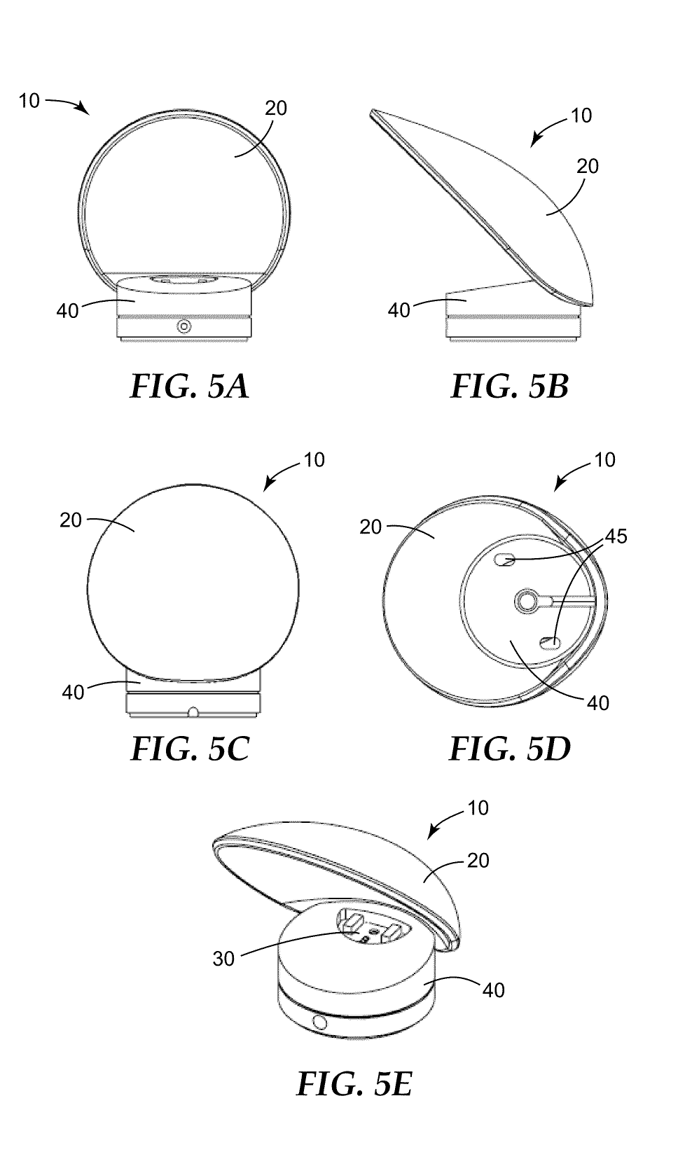

With reference to the embodiment depicted in FIGS. 1-3 and 5A-E, light fixture 10 includes reflector 20 and light source 30, typically an LED, mounted in base 40. Base 40 may include mounting holes 45. Light fixture 10 may be mounted on wall 100 by base 40. When lit, as depicted in FIG. 1, light fixture 10 may cast a line of light 200 on wall 100.

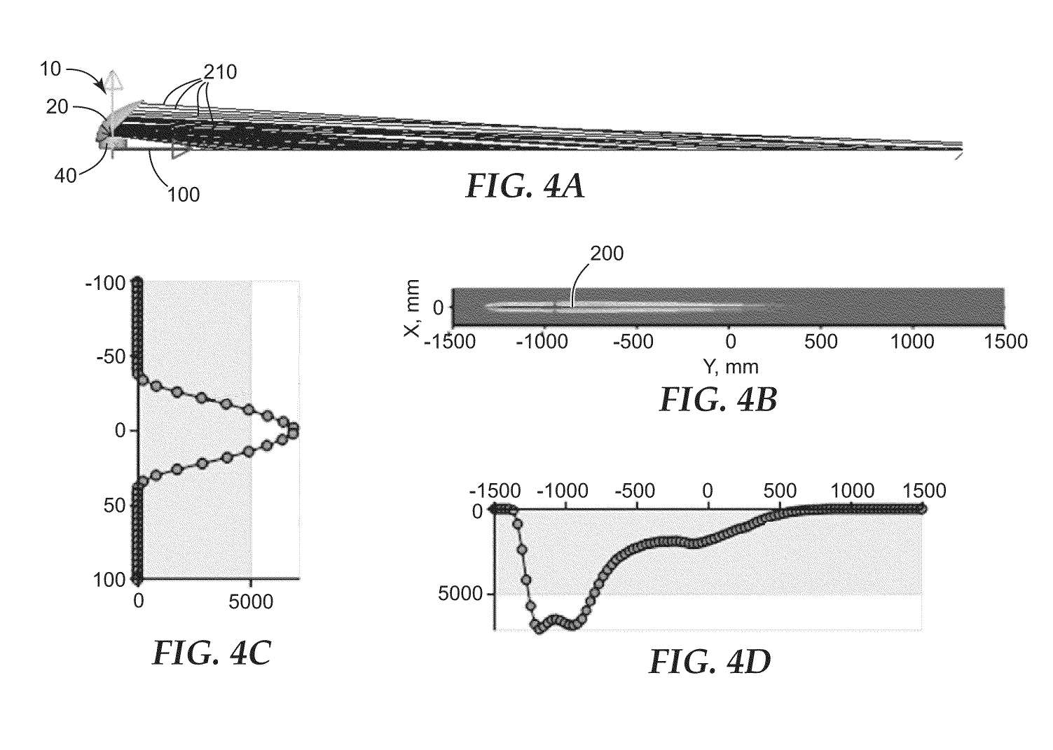

FIGS. 4B-D represent a simulation of a light fixture according to the present disclosure. Depicted light fixture 10 has a depth of 85 mm and contains a 300 lumen LED light source.

FIG. 4A depicts a side view of one embodiment of a light fixture 10, including reflector 20 and base 40, mounted on wall 100. FIG. 4A additionally depicts light rays 210 emanating from light fixture 10 and striking wall 100, illustrating the redirection of light from the light source onto a planar surface. FIG. 4B is a two dimensional graph illustrating the essentially linear pattern 200 in the distribution of light emanating from the light fixture. FIG. 4C is a graph illustrating the distribution of light across the essentially linear pattern. FIG. 4D is a graph illustrating the distribution of light along the length of the essentially linear pattern. The line of light 200 cast by light fixture 10 extends more than 1500 mm from the light fixture. Illuminance on the wall at 1830 mm (about 6 feet) from the light fixture is about 1000 lux. Total light efficiency on the wall is approximately 75%.

### Selected Embodiments

The following embodiments, designated by letter and number, are intended to further illustrate the present disclosure but should not be construed to unduly limit this disclosure.

1. A reflector having a reflecting surface having a shape which closely approximates a determined surface which is series of ellipsoidal section segments, wherein each ellipsoidal section segment has a first focus A and a second focus B, wherein first focus A is the same point for each ellipsoidal section segment, and wherein, for successive ellipsoidal section segments, focus B is at a successive location along a line.
2. The reflector according to embodiment 1 wherein the line is a straight line.
3. The reflector according to embodiment 1 wherein the line is a curved line.
4. The reflector according to embodiment 1 wherein the line is a curved line curving in a single direction.
5. The reflector according to embodiment 1 wherein the line is a curved line curving successively in alternating directions.
6. A light fixture comprising the reflector according to any of the preceding embodiments.
7. The light fixture according to embodiment 6 additionally comprising a light source.
8. The light fixture according to embodiment 6 additionally comprising a light source located at focus A.
9. The light fixture according to embodiment 7 or 8 wherein the light source is a lambertian light source.
10. The light fixture according to any of embodiments 7-9 wherein the light source is an LED.
11. The light fixture according to any of embodiments 6-10 wherein the reflecting surface has a shape which closely approximates the determined surface in that it varies by less than +/−10% from the determined surface.
12. The light fixture according to any of embodiments 6-10 wherein the reflecting surface has a shape which closely approximates the determined surface in that it varies by less than +/−5% from the determined surface.
13. The light fixture according to any of embodiments 6-12 which is adapted to be mounted on a planar surface, such that when mounted said line will fall in the plane of the planar surface.
14. The light fixture according to embodiment 13 wherein the planar surface is a wall of a building.
15. The light fixture according to embodiment 13 or 14 having a depth, such that when mounted the depth is measured orthogonal to the planar surface, wherein the depth is not more than 15 cm.
16. The light fixture according to embodiment 15, wherein the depth is not more than 12 cm.
17. The light fixture according to embodiment 15, wherein the depth is not more than 10 cm.
18. The light fixture according to embodiment 15, wherein the depth is not more than 9 cm.
19. The light fixture according to any of embodiments 15-18, wherein the depth is not more than 10% of the length of the line measured from the light fixture.
20. The light fixture according to any of embodiments 15-18, wherein the depth is not more than 6% of the length of the line measured from the light fixture.
21. The reflector according to any of embodiments 1-5 wherein the reflecting surface has a shape which closely approximates the determined surface in that it varies by less than +/−10% from the determined surface.
22. The reflector according to any of embodiments 1-5 wherein the reflecting surface has a shape which closely approximates the determined surface in that it varies by less than +/−5% from the determined surface.

Various modifications and alterations of this disclosure will become apparent to those skilled in the art without departing from the scope and principles of this disclosure, and it should be understood that this disclosure is not to be unduly limited to the illustrative embodiments set forth hereinabove.

We claim:

1. A reflector having a reflecting surface having a shape which closely approximates a determined surface which is series of ellipsoidal section segments, wherein each ellipsoidal section segment has a first focus A and a second focus B, wherein first focus A is the same point for each ellipsoidal section segment, and wherein, for successive ellipsoidal section segments, focus B is at a successive location along a line.

2. The reflector according to claim 1 wherein the reflecting surface has a shape which closely approximates the determined surface in that it varies by less than +/−10% from the determined surface.

3. The reflector according to claim 1 wherein the line is a straight line.

4. The reflector according to claim 1 wherein the line is a curved line.

5. The reflector according to claim 1 wherein the line is a curved line curving in a single direction.

6. The reflector according to claim 1 wherein the line is a curved line curving successively in alternating directions.

7. A light fixture comprising the reflector according to claim 1 and additionally comprising a light source located at focus A.

8. The light fixture according to claim 7 wherein the light source is an LED.

9. The light fixture according to claim 7 which is adapted to be mounted on a planar surface, such that when mounted said line will fall in the plane of the planar surface.

10. The light fixture according to claim 9 having a depth, such that when mounted the depth is measured orthogonal to the planar surface, wherein the depth is not more than 15 cm.

11. The light fixture according to embodiment 10, wherein the depth is not more than 12 cm.

12. The light fixture according to embodiment 10, wherein the depth is not more than 10 cm.

13. The light fixture according to embodiment 10, wherein the depth is not more than 9 cm.

14. The light fixture according to embodiment 10, wherein the depth is not more than 10% of the length of the line measured from the light fixture.

15. The light fixture according to embodiment 12, wherein the depth is not more than 10% of the length of the line measured from the light fixture.

16. The light fixture according to embodiment 10, wherein the depth is not more than 6% of the length of the line measured from the light fixture.

17. The light fixture according to embodiment 12, wherein the depth is not more than 6% of the length of the line measured from the light fixture.

18. The reflector according to claim 10 wherein the line is a straight line.

19. The reflector according to claim 14 wherein the line is a straight line.

20. The reflector according to claim 17 wherein the line is a straight line.
